(19) United States
(12) Patent Application Publication
(10) Pub. No.: US 2006/0273048 A1
(43) Pub. Date: Dec. 7, 2006

(54) Internally fed rotary screen manure separator

(75) Inventors: Kerry Doyle, Abbotsford (CA); Balbir Sidhu, Surrey (CA); Dave DeWaard, Lynden, WA (US)

Correspondence Address: CRAIG TAYLOR LAW OFFICE, PLLC, 774 RANDY AVE., SHOREVIEW, MN, 55124-2905, US

(73) Assignee: Accent Manufacturing, Inc., Abbotsford (CA)

(21) Appl. No.: 11/153,661

(22) Filed: Jun. 15, 2005

Related U.S. Application Data
(60) Provisional application No. 60/686,239, filed on Jun. 1, 2005.

(51) Int. Cl. B04B 3/00

(52) U.S. Cl. 210/781; 210/369

(57) ABSTRACT

Systems and methods for separating manure into a solid fraction and a liquid fraction, and optionally further separating the liquid fraction to capture a sand-rich second solid fraction and a second liquid fraction. Some separators have an adjustable inclination, forcing the manure passage to be slightly up hill, with an overflow box capturing and re-feeding excess manure inflow. One system includes an internally fed rotary screen separator having a perforated outer tube, the perforations being holes less than about 3/16 inch diameter. The outer tube can include spiral inner flights which may be interrupted near the discharge end to allow free fluid to flow back into the separator. The manure can be fed into an inlet conduit having an adjustable angle discharge slot. Some outer tubes have non-perforated end regions serving as the foundation for drive tracks. The solid fraction discharge can be further dewatered in a roller press. Scrape barn, flush barn, sand bedding, straw bedding, and other manure may be handled using these systems and methods.

### RELATED APPLICATIONS

The present application is a non-provisional of U.S. Provisional Patent Application No. 60/686,239, filed Jun. 1, 2005, titled ROTARY SCREEN MANURE SEPARATOR, herein incorporated by reference in its entirety.

### FIELD OF INVENTION

The present invention is related generally to manure separators. More specifically, the present invention is related to internally fed rotary screen separators or thickeners.

### BACKGROUND

Livestock production and farming has changed significantly in recent decades. In dairy farms, for example, cows used to be located within stanchions or fixed stalls, and had straw or other fiber bedding beneath them. Shovels could then be used to collect the manure, which would often be thrown into a gutter, and later scraped and collected in a central area.

Free stall barns were then used, where the animals had a choice as to which stall to be in. The animal bedding could be either organic or inorganic. Examples of organic bedding include straw, waste paper, rice hulls, or other organic materials. One example of inorganic material includes sand. In the free stall barns, the animals typically kick the manure out of the stalls themselves, where it is scraped or flushed away. In scraped systems, a blade or cable can be automatically pulled to remove the manure, leaving manure with at least about 4%, or even 5% solids. Some scrape systems use mechanical scrapers to scrape the manure to gutters, where water is used to flush the manure from the gutters.

In flush systems, often termed “flush barns”, a large, for example, 3000 to 10,000 gallon water flush is used to flush the manure from the stalls and from the gutters. A wash or flush cycle may last on the order ½ hour, during which time the density of the effluent can vary from a very watery mixture to a mixture having higher solids content, as different portions of the manure and water mixture are washed from the gutters. In some barns, the effluent may vary from ½% to about 6% over a half hour, during a single flush or wash cycle. Flush manure typically has less than about 3% solids, often about 2½% solids on average. Some farms use a large holding tank with mixing in an attempt to maintain a consistent solids content over time. This requires yet more equipment and complexity.

Sand is a good bedding material. When organic materials are used as bedding, the organic material tends to support the growth of bacteria. The organic material in the bedding together with the manure can cause an unacceptably high rate of bacterial growth. This can lead to diseases in cows, for example, mastitis. For this reason, inorganic material such as sand is often preferred. The sand does not support bacterial growth to the same extent as organic materials, and is often preferred by the animals. Milk production increases when the animals rest, a for example, lying on the bedding. The more attractive the bedding to the animals, the higher the milk production. Cows like to lie in sand, which increases the amount of time they spend lying down which increases milk production.

The use of sand brings its own problems. Sand is extremely abrasive, which is why it is used in sandblasting and sandpaper. The sand tends to be mixed with the manure, making handling the manure even more difficult. Pumping the manure containing sand quickly degrades pumps and other handling devices.

Rotary screen filters or rotary screen thickeners are generally well known. They are often used to wash food or to separate liquid and solid streams. A solid-liquid mixture can be fed into the exterior or interior of the rotating screen, with the liquid passing through the openings in the screen. The screen is often a form of wedge wire or V-bar material. The wedge wires for an internally fed rotary screen are typically made by placing the wedge wires with the largest, flat portion of the wedge wire inward and the narrow portion pointing outward, with the wires laid along the longitudinal axis of the tube. A series of wrap wires may be wound around the outside of the wedge wires and welded at each intersection to maintain the wedge wire spacing. The solid fraction may sometimes be collected or scraped from the inside of the rotating tube near the top of the rotation. In other systems, flights located helically within the rotating screen may carry the solid fraction to the end. Applicants believe that such systems have been very ineffective with manure streams, in particular, sand carrying manure streams. The manure has tended to plug or blind the slots in the screen, rendering the rotating screens largely ineffective. This appears to be caused by the fiber material wrapping around the wire material of the wedge wire or V-wire, in particular at the intersection of the wedge wire and the wrap wire. Fiber, e.g. corn silage fiber or grass, can pass through the wedge wire and become caught around the wrap wire.

In the past, wedge wire or V-wire separator screens were tried by others. Such rotary screens quickly plug up with the fibrous material, and no longer separate well, if at all. In an effort to force manure through wedge wire, screw presses can be used to force the mixture through the opening and scrape the surface of the tube. Applicants believe that screw presses used with sand laden manure would quickly destroy the machinery due to the abrasion of the sand. The fiber can come from the grass or hay going through the animal, or from the bedding itself. This is one major difference between animal manure and some other solid-liquid mixtures for which internally feed rotary screens have worked well. Animal manure has thus proven difficult to separate due to both the fiber content and the sand. The sand may come from the great outdoors and/or sand bedding used for the animals.

Attempts have been made to remove the sand before performing much of the manure transport and storage. In the past, others have tried to pass the manure solid-liquid mixture through a settling channel, in an attempt to settle out the sand due to its density and the low velocity of the channel flow. Such channels are often concrete channels. This tends to be inefficient, with the manure still containing a large amount of sand. Such settling may be performed before and/or after removing some of the solids from the manure.

What is left is a viscous, difficult to pump material having a high solids content and a high sand content. While not wishing to be tied to a theory, applicants believe that the fibrous content may prevent the sand from settling out in the channel. It is desirable to remove the sand to reduce wear on downstream pumps and machinery. The viscous mixture having some sand removed is typically pumped to a storage lagoon and may later be pumped again onto fields. Some parties remove some water by using belt presses or screw presses.

What would be advantageous is a system for separating a significant portion of the solids content, including a significant amount of sand, from the manure at a point near the point of generation. In particular, it would be advantageous to remove a significant amount of solids and sand from the manure stream at a location close to the barn. This would reduce the amount of sand and solids generally which need to pass through pumping and other handling equipment. What would also be desirable is a system which can function at both low and high density levels occurring during a wash or flush cycle of barns. What would also be desirable is a system which can handle low, medium, and large manure flow rates without requiring manual intervention.

### SUMMARY

The present invention provides a device for separating an animal manure inlet stream into a first, more liquid outlet stream and a second, more solid outlet stream. The device can include: a housing; a tube rotatably disposed within the housing, the tube having an inlet end, an outlet end, a tube wall, an inside surface, a wall thickness, and a plurality of apertures through the wall thickness. The device can also include a motor coupled to rotate the tube and a feed conduit disposed within the tube near the tube inlet end, the feed conduit having at least one conduit aperture for directing manure toward the tube inner surface. The tube apertures may have an average inside dimension of less than about ¼ inch, 3/16 inch, ⅛ inch, or may have an average inside dimension of about 1/16 inch, depending on the embodiment. The tube apertures can have a substantially circular shape, wherein the average inside dimension is an average inside diameter. The wall thickness can be less than about 12 gauge or 14 gauge, or be equal to about 16 gauge, in various invention embodiments.

In some devices, the motor rotatable coupling to the tube includes a first drive wheel driven by the motor and urged against the tube outer surface to engage the tube outer surface at a first end region to drive the tube rotation through a frictional force. In some devices, a second drive wheel is driven by the motor and urged against the tube outer surface to engage the tube outer surface at a second end region opposite the first end region to drive the tube rotation through a frictional force. The first drive wheel may drive a portion of the outer tube through which liquid cannot flow. Some drive wheels are formed of a polymeric material, which may include polyurethane.

In some devices, the tube includes a drive track disposed about a tube outer circumference, the drive track being formed of a drive track material which is of a different material and/or surface configuration than the perforated tube wall, in which the drive track is adapted to receive the drive wheel. The drive track can include a perforated metal disposed over a solid metal, and may also have a lip on both sides of the track, which can be formed by a pair of angle irons.

Some devices also include an overflow collector disposed near the tube inlet end to catch manure overflowing the tube inlet end. This can provide means for automatically handling larger inflows without requiring operator attention.

In some separator devices, the feed conduit has an elongate shape, and the feed conduit aperture includes a slot disposed along the conduit length. The feed conduit may be configured to be rotated to adjust the angle of incidence of manure exiting the slot and impinging the tube wall inner surface. The feed conduit may also be configured to be axially adjustable to vary the penetration depth into the outer tube, of the manure impinging the outer tube wall inner surface.

The separator outer tube can include at least one inner protrusion helically disposed on the tube inner wall, where the protrusion may include at least one flight helically disposed on the tube inner wall. In some devices, a pair of helical flights are disposed within the outer, perforated, tube, 180 degrees out of phase, and continue for about 3 turns each about the inside of the outer tube. Some flights are interrupted at least once or twice toward the outer tube outlet to allow fluid still in the solid fraction to flow downhill, toward the inlet, and perhaps flow out through the outer tube perforations.

Some separators also include means for adjusting the inclination of the tube relative to horizontal. In some devices this includes adjustable height legs. This allows fine tuning the separator to different operating conditions and manures.

In some systems according to the present invention, a roller press is disposed to receive the solid fraction material discharged from the rotating outer tube. Systems may also include a settling chamber coupled to receive a liquid fraction that has passed through the rotating outer tube perforations, for settling out sand from the liquid fraction.

One separating device for separating an animal manure inlet stream into a first, liquid fraction outlet stream and a second, solid fraction outlet stream includes: a housing and a tube rotatably disposed within the housing, the tube having an inlet end, an outlet end, a tube wall, an inside surface, a wall thickness, and a plurality of apertures through the wall thickness. The device can include a motor operably coupled to rotate the tube and a feed conduit disposed within the tube near the tube inlet end, the feed conduit having at least one conduit aperture for directing manure toward the tube inner surface. The tube apertures can have an average inside dimension of less than about ⅛ inch and take up at least about ⅓ or at least about 40 percent of the tube surface. Various embodiments have tube wall perforation inside areas of less than about 0.05, 0.04, 0.03, 0.02, and even 0.01 square inches. The outer tube can have a wall thickness thinner than about 12 gauge.

The device motor rotatable coupling to the tube can include a drive wheel driven by the motor and urged against the tube outer surface to engage the tube outer surface to drive the tube rotation through a frictional force, the device having at least one drive wheel at each end of the outer tube, and in which the outer wheel drives a portion of the outer tube through which liquid cannot flow. The device may also have at least one inclination adjustment member operably coupled to the frame.

The present invention also provides methods for separating an animal manure inlet stream into at least two outlet streams. One method includes: discharging the manure inlet stream against the inner rotating wall of a rotating tube having a plurality of perforations therethough; collecting a first outlet stream comprising fluid that has flowed through the wall perforations; and collecting a second outlet stream comprising solids that have been carried to the end of the rotating tube, wherein the second outlet stream has substantially higher solids content than the first outlet stream, wherein the second outlet stream collecting continues for at least one hour without requiring cleaning due to plugging. The manure is preferably not substantially mechanically pressed against the inner rotating tube wall, as, for example it would be with a screw press.

In some methods, the tube wall perforations have an average, inside dimension of less than about ¼ inch, 3/16 inch, ⅛ inch, or equal to about 1/16 inch. The tube wall may have a wall thickness thinner than about 12 gauge, 14 gauge, or equal to about 16 gauge, in some methods.

Some methods include the tilting the outer tube at least about 3 degrees relative to horizontal upward in the direction of the outlet end. This can assist excess inlet manure in flowing to an overflow vessel and also assist liquid near the outer tube outlet in flowing back through interrupted flights. In some methods, at least some of the inlet stream overflows the inlet end of the rotating tube into a vessel and is pumped back into the inlet stream.

In some methods, the inlet manure has a percent solids of at least about 2, 3, 4, or 5 weight percent. The present invention can work with scrape barn manure and flush barn manure and can handle some variations in manure composition without requiring manual adjustments.

Some methods include adjusting the discharge upward responsive to higher inlet flow rates and downward responsive to lower inlet flow rates. The methods may include discharging the manure from an inlet conduit, wherein the discharge occurs through at least one aperture in the inlet conduit, where the inlet conduit aperture includes at least one elongate slot.

Methods can include receiving in the first outlet stream at least about 50 weight percent of the inlet manure stream, and receiving in the second outlet stream at least about 40 weight percent of the solids in the inlet manure stream. Methods may include receiving the first outlet stream in an amount of at least about 70 weight percent of the inlet stream and receiving the second outlet stream having at least about 50 weight percent of the solids in the inlet stream. Methods may also include sending the second outlet stream from the rotating outer tube to a roller press and further removing liquid from the second outlet stream using the roller press to produce a roller press solid fraction. The roller press solid fraction may have less than about 80 or 75 weight percent liquid.

One method for separating an animal manure inlet stream into at least two outlet streams includes: discharging the manure inlet stream against the inner rotating wall of a rotating tube having a plurality of perforations therethough, in which the rotating tube has an inlet end and an outlet end, in which the tube wall perforations have an average inside dimension of less than about ¼ inch or less than 3/16 inch, in which the tube wall has a wall thickness thinner than about 12 gauge. The method can include collecting a first outlet stream comprising fluid and material that has flowed through the wall perforations; and also collecting a second outlet stream discharged from the tube outlet end, where the second outlet stream has substantially higher solids content than the first outlet stream. The manure inlet stream can have a percent solids of at least about 2 weight percent. The second outlet stream can comprise at least about 10 weight percent solids and contain at least about 50 percent of the solids in the inlet stream manure. Some manure inlet streams comprise at least about 10 weight percent sand. The collecting can easily continue for over an hour, or two, or more, without plugging the outer tube and requiring shut down.

### DESCRIPTION OF THE DRAWINGS

FIG. 1 is a block diagram and flow chart of a manure separation system including an internally fed rotary screen separator, a roller press, and a settling channel.

FIG. 2 is a top, front, perspective view of one embodiment of the invention having the inlet distribution tube extending into the rotatable perforated outer tube and over the overflow box.

FIG. 3 is an end, perspective view of the manure separator of FIG. 2.

FIG. 4 is a bottom, perspective view of the manure separator of FIG. 2.

FIG. 5 is an exploded view of the manure separator of FIG. 2.

FIG. 6 is an exploded view of the drive system of the manure separator of FIG. 2.

FIG. 7 is a side view of the inlet feed tube extending over the overflow box.

FIG. 8 is an end, perspective view of the discharge slot in the inlet feed tube.

FIG. 9 is a fragmentary, perspective view of the drive track of the manure separator of FIG. 2.

FIG. 10 is a fragmentary, inside view of the perforated outer tube, flight, and solid drive track portion of the outer tube.

FIG. 11 is an end, perspective view of the discharge end of the separator of FIG. 2, showing the interrupted flights.

FIG. 12A is a perspective view of a manure separator in operation, having liquid manure discharged from the inlet tube feed slot.

FIG. 12B is a perspective view of a manure separator in operation, having drier, fibrous manure discharged from outer tube outlet.

FIG. 13 is a bottom, perspective view of the manure separator of FIG. 2 in operation, having the discharge further processed by a roller press unit.

FIG. 14 is a photograph of a system similar to that in FIG. 13, showing the discharge and angle of repose of the solid fraction discharged from the roller press, from sand bedding dairy flush barn manure.

FIG. 15 is a photograph of a system similar to that in FIG. 13, showing the discharge and angle of repose of the solid fraction discharged from the roller press, from straw bedding dairy flush barn manure.

FIG. 16A is a photograph of a manure separator in operation, having liquid manure discharged from the inlet tube feed slot.

FIG. 16B is a photograph of a manure separator in operation, having drier, fibrous manure discharged from outer tube outlet.

### DETAILED DESCRIPTION

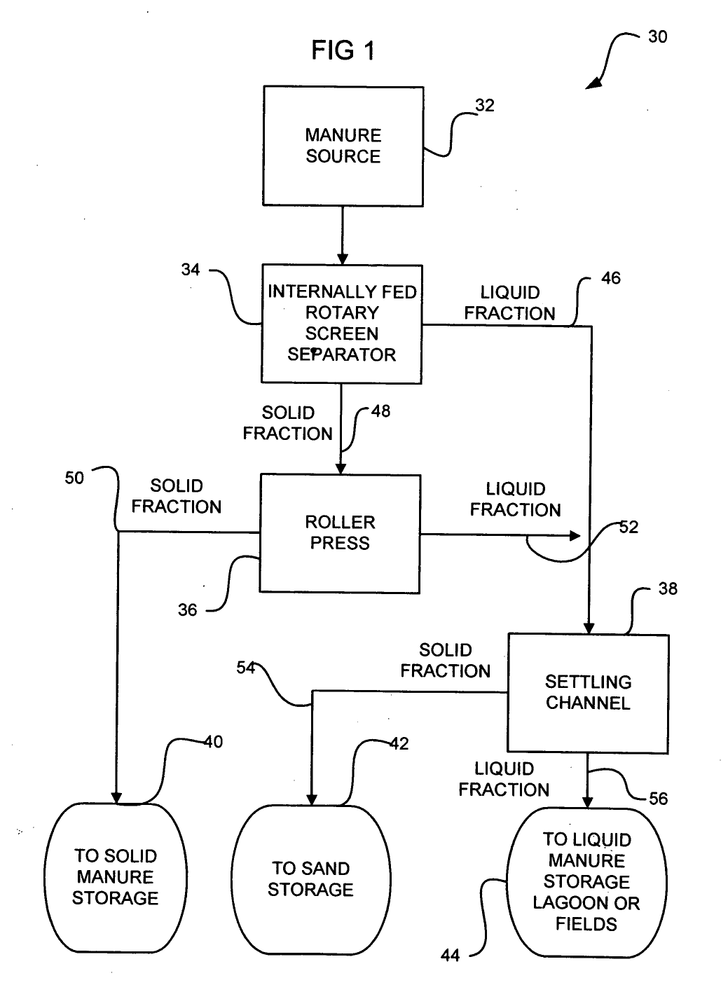

FIG. 1 is a highly diagrammatic flowchart of one manure separation system 30 according to the present invention. System 30 includes generally a manure source 32. The manure source can be any one of a number of sources, for example, dairy barn manure, piggery manure, scrape barn manure, or flush barn manure, where the manure may include bedding material including sand, sawdust, straw, and other materials. In the flush barn example, the manure source may vary in solids concentration periodically between ½ percent and about 6% solids. The manure can include undigested feed having a high fiber content, sand, other bedding material, urine, and water.

The manure can be fed to an internally fed rotary screen separator 34, typically under pressure from a pump. A liquid fraction 46, which passes through the perforated screen of the rotary screen separator, can include water, urine, and sand. A solid fraction 48 is typically discharged from the end of the rotary screen separator, having material which has not passed through the perforations in the screen. In some systems, solid fraction 48 is further dewatered. In one such system, solid fraction 48 passes to a roller press 36. The solid material entering the roller press may enter into a hopper where it may be carried into the nip between an upper gum roll and a lower perforated screen roll. Some liquid may be expelled into the interior of the perforated screen roll, exiting as a liquid fraction 52. A solid fraction 50 may be expelled from the nip of the roller press, dropping into a pile to be stored in a solid manure storage facility 40.

Liquid fraction 46 from the rotary screen separator and Liquid fraction 52 from the roller press may enter a settling channel or other settling basin or device 38. In one embodiment, liquid fraction 52 is added back to manure source 32 or to the pump feeding separator 34, to capture solids forced through the screen of the roller press bottom roll A change in velocity of the liquid entering the settling channel can allow the sand carried in the liquid fraction to drop out. The settled sand forms a solid fraction 54 which can be removed and stored in sand storage 42. The portion exiting the settling channel forms a liquid fraction 56 which can then be pumped to a storage lagoon or directly to fields, indicated at 44.

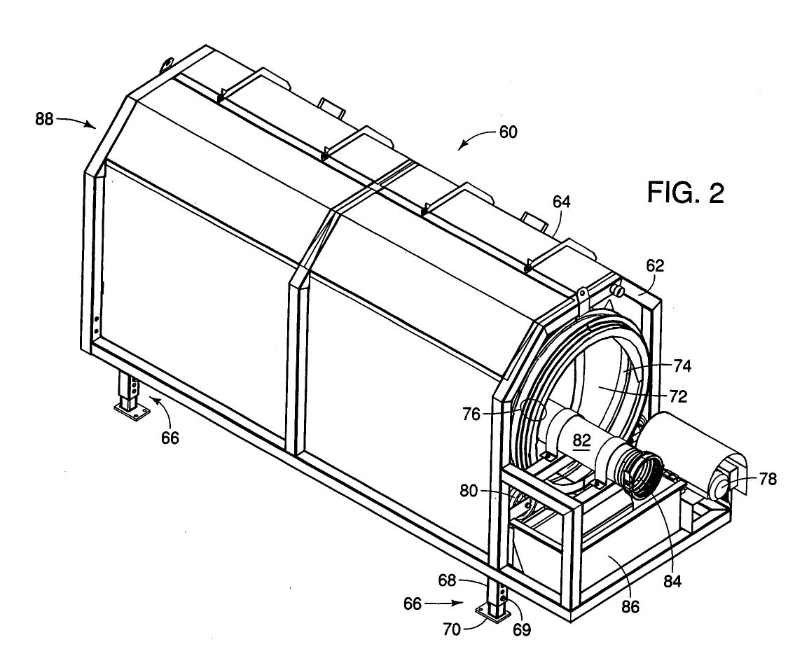

FIG. 2 illustrates one embodiment of the present invention in a manure separator 60. Manure separator 60 may be referred to generally as an internally fed rotary screen separator. Separator 60 may be seen to generally have a frame 62 having an outer housing including hinged covers 64 to provide access to the inside of the separator. Legs 66 may be seen coupled to frame 62, where legs 66 may be adjustable in height. Legs 66, in the example illustrated, include an outer portion 68 having holes therethrough and an inner portion 70 slidably received within outer portion 68. Bolts 69 may be used to adjust the height of the various legs. The adjustable height legs are but one type of inclination adjustment that is within the scope of the invention. Screw jacks, blocks, and many other inclination adjustment mechanisms may also be used and are within the scope of the invention.

A rotatable perforated tube 72, having flights 74, may also have an outer drive track 76 driven by a motor 78 through a drive wheel on one side and carried by an idler wheel 80 on the opposite side. In some separators according to the present invention, tube 72 is about 3 feet in diameter and about 8 or 10 feet long. An inlet conduit or tube 82 may be seen, having an inlet 84. Inlet conduit 82 may be between about 2 and 4 feet in some embodiments, about 3 feet long in one such embodiment, preferably closed at the end opposite the conduit inlet. An overflow box, collection box, or recycle box 86 may also be seen, for catching liquid flowing from the inlet end of perforated tube 72, to be pumped back into inlet 84. Adjustable legs 66 or other inclination control means can be used to make the discharge end of outer tube 72 higher than the inlet end, sometimes on the order of about 3-4 degrees. When a high flow rate of manure occurs, the excess can simply run “downhill”, out the inlet end of outer tube 72, to overflow box 86, and back to the pump or manure storage to be pumped again later. This can provide for automatic, unattended use with respect to flow rates, as excess flow is simply sent back, rather than interfere with the separator operation or require constant separator adjustment.

In use, manure can be pumped into inlet conduit 84 and allowed to discharge from at least one distribution aperture or slot in the side of inlet tube 82. The manure should preferably be discharged from one side only, the side toward the screen rather than the side toward the center of the screen or the end toward the rotating screen solid discharge end. The inlet conduit is preferably a conduit that is closed on the end and on the side toward the screen center, to allow flow only along one side. The manure spray may be in a direction so as to flow against the rotational direction of perforated tube 72. The liquid fraction can flow through holes in perforated tube 72 and be captured by a drain system and removed from separator 60. The solid fraction can be discharged from a discharge end 88 of separator 60.

The perforated tube can be formed from about 16 gauge 304 SS sheet, perforated with holes varying from about 3/16 inch to about 1/16 inch, depending on the embodiment. 3/16, ⅛, and 1/16 inch diameter holes have all been used by applicants. Holes less than about ⅛ inch in diameter, and an outer tube made from sheets thinner than about 12 gauge are both within the scope of the invention. Some sheets have perforations of about 0.062 inch with about a 0.109 inch stagger. The perforated sheet material can be purchased from Uniloy (Langley BC, Canada). The holes may have been be formed by punching, leaving a flared, larger opening on one side of the sheet. In one embodiment, the flare is located on the outside of the tube. Placing the larger inside diameter portion of the hole on the outside may allow particles once in the opening to be discharged from the opening, rather than being stuck in the opening.

The perforated tube may be made by welding three perforated sheets together, end to end, with each sheet covering about 36 inches. The perforated tube may be welded on each end to a non-perforated section, to serve as the foundation of the drive track.

Applicants also believe that perforated sheet is better able to be driven using the drive system of the present invention. Applicants believe that prior art wedge wire tubes may be driven from one end, with the other end allowed to follow after some twisting due to the tube structural characteristics in combination with the manure within. The present invention can allow both ends to be driven with less flexure.

Applicants have learned that having an inlet tube slot too short reduces capacity of the unit, as expected, as the flow into the perforated outer tube is less. Applicants were surprised to learn that lengthening the slot also reduces capacity. Applicants believe that this may be because fresh slurry is being added to already partially dewatered slurry.

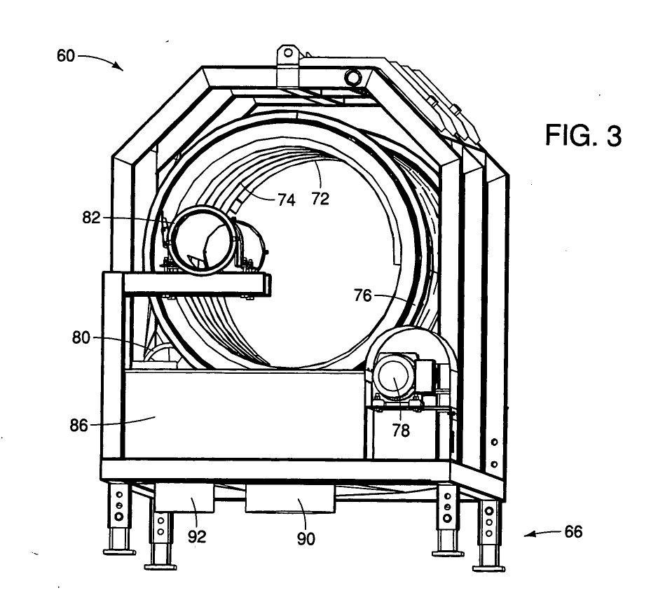

FIG. 3 again illustrates manure separator 60, better illustrating inlet tube or conduit 82 disposed within perforated tube 72. A liquid fraction outlet 90 may be seen for discharging the liquid fraction which has passed through the perforations in perforated tube 72. An overflow discharge outlet 92 may also be seen, for discharging the accumulated overflow from overflow box 86. The manure from outlet 92 may flow into the manure source and be pumped back into inlet tube 82. Flights 74 may also be seen, spiraling helically about the inside of perforated tube 72. In some embodiments, the flights are about 2 feet apart. Drive motor 78 and idler wheel 80 may also be seen, as previously described.

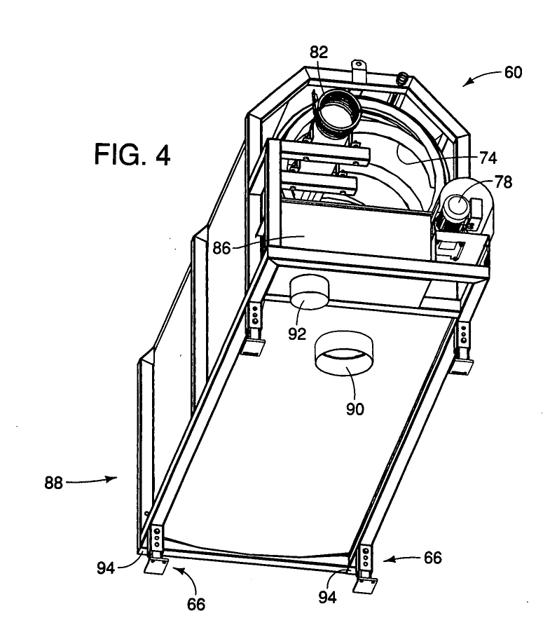

FIG. 4 again illustrates separator 60, showing flights 74, drive motor 78, inlet tube 82, recycle or overflow box 86, liquid fraction discharge 90, and overflow discharge 92, all as previously described. Near outer tube rear portion 88, legs 66 may be offset toward the front in some embodiments, allowing access to a pair of rear channels 94. In some embodiments, frame members of a roller press unit may be inserted up into channels 94 to couple the roller press unit to receive the solid fraction discharge from separator 60.

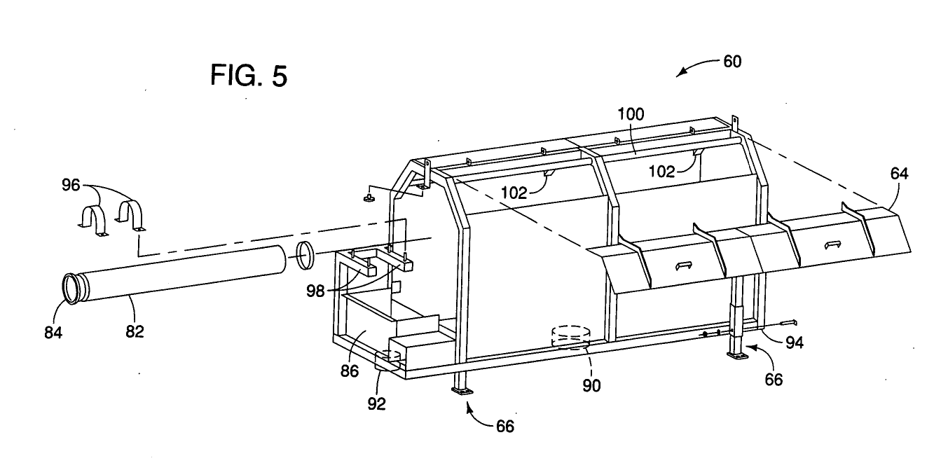

FIG. 5 illustrates the manure separator 60 in an exploded view. A pair of tube clamps 96 may be seen for securing inlet tube 82 to a pair of tube support arms 98. Tube clamps 96 may be loosened to allow the rotational and/or translational movement of inlet tube 82. This can be used to adjust the depth into the separator outer tube in which the discharge occurs, and also to adjust the angle of the discharge flow into and onto the rotating perforated screen. A spray bar 100 and corresponding nozzles 102 may also be seen, used for a clean in place (CIP) procedure. All other reference numerals reference elements previously described.

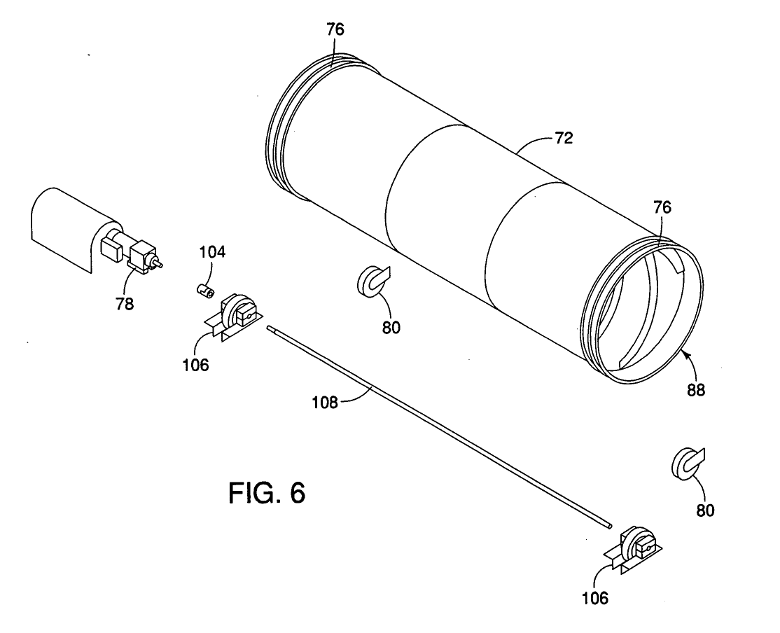

FIG. 6 illustrates the rotary screen drive system in more detail. Perforated tube 72 and drive tracks 76 are as previously described. Drive motor 78 and idler wheel 80 are also as previously described. Drive motor 78 may be a three quarter horsepower SEW Euro VFD drive unit, in some embodiments. L. Joy Drive coupling 104 may be used to couple drive motor 78 to a rotary screen drive wheel assembly 106. Drive wheel assembly 106 can be coupled to a drive shaft 108 which is in turn coupled to another drive wheel assembly 106. Drive wheels 106 and idler wheels 80 may both rotate within drive tracks 76.

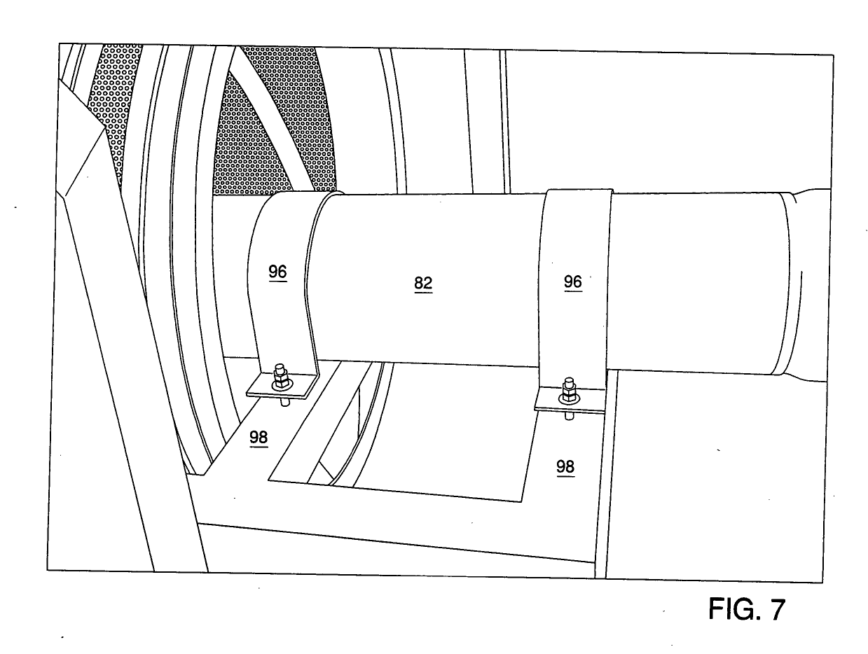

FIG. 7 illustrates inlet tube 82, tube clamps 96, and tube support arms 98, as previously described. The interior of outer tube 72 may also be seen.

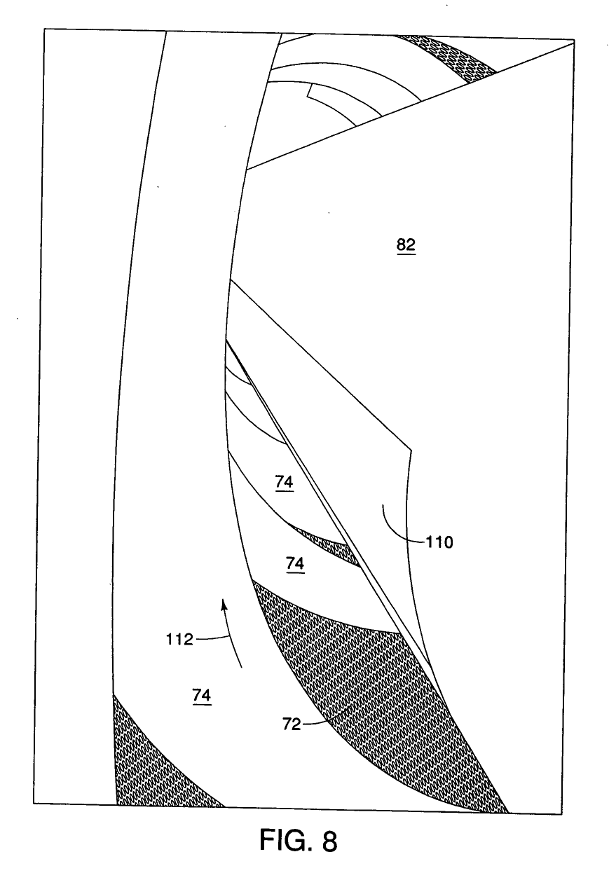

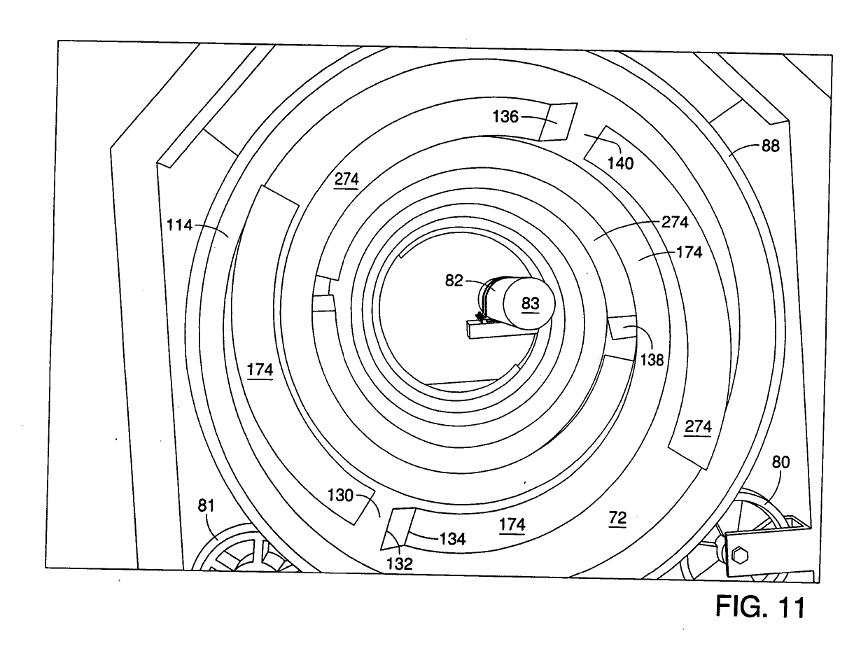

FIG. 8 shows tube 82, illustrating a discharge aperture or slot 110. In one embodiment, only one slot is present, and is about 2 inches high and about 3 feet long, in an 8 inch diameter inlet tube. In other embodiments, multiple discharge apertures or orifices may be used. Internal flights 74 and the interior wall of perforated tube 72 may be seen as previously described. In FIG. 8, the slot 110 is positioned at about 9 o'clock. The angular disposition of discharge slot 110 may be adjusted by loosening and retightening tube clamps 96 as previously described. In some uses, the tube is rotated between about 8 o'clock and 10 o'clock, or between 7 o'clock and 11 o'clock, looking into the perforated screen inlet end. The longitudinal or translational position of slot 110 may also be adjusted using the tube clamps. In this way, the depth of the discharge into perforated tube 72 can be controlled. The rotational direction of tube 72 is indicated at 112. After discharge the manure falls and contacts the rotating perforated tube 72 in a counter-flow approach. In some models, the discharge slot or orifice is located about 2 inches from the perforated screen. The inlet tube or conduit is preferably open only on the side nearest the screen, not toward the center, and not toward the end 83 (shown in FIG. 11).

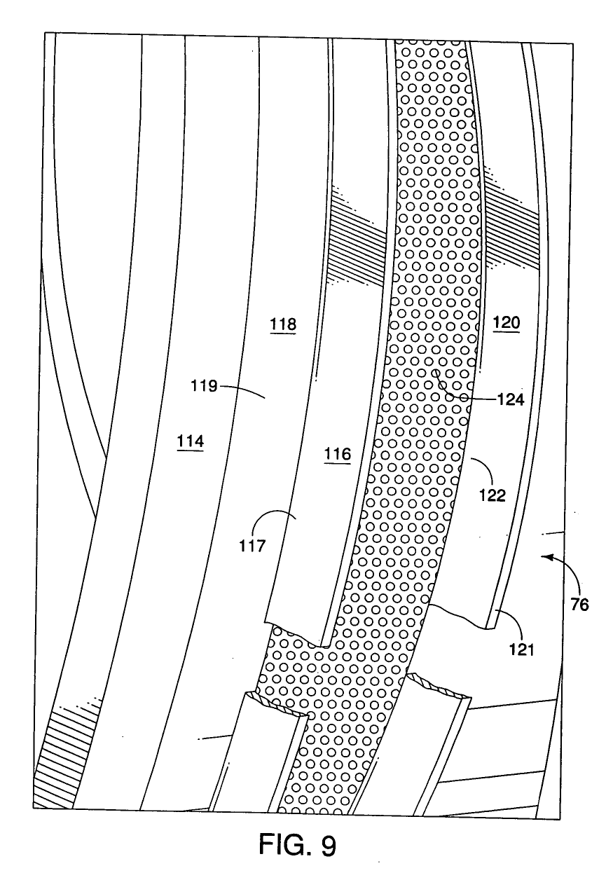

FIG. 9 illustrates drive track 76 in more detail. In one embodiment of the invention, the outer tube has a non-perforated, solid sheet region secured to each, opposite end. A solid sheet of stainless steel may be welded to each end of the perforated tube, providing a tube region through which the manure mixture cannot pass. This has one advantage of not contaminating the drive wheels or drive system. Applicants believe that this was a drawback of some previous systems (if applied to manure) which may be acceptable for washing food, but not for handling sand laden manure water passing through the perforated screen and coating the drive mechanism. The perforated tube can have its length extended by the non-perforated, solid portion. Such a solid tube region is illustrated at 114. In one embodiment, a drive track, for example, drive track 76 is formed by bringing two pieces of angle iron 119 and 121 in close proximity to each other, forming a channel or drive track therebetween.

First angle iron 119 may be seen to have a first portion 116 that extends transversely away from the perforated tube, extending downward to a bend 117, and then extending to a second portion 118 that is coaxial with the outer tube. Second angle iron 121 includes a similar transversely extending portion 120 which may be welded at 122 to a perforated track 124. Perforated track 124 may be welded over non-perforated tube 114 to provide a drive track for the drive wheel secured to the drive motor. In some separators according to the present invention, the non-perforated strip is about 6 inches wide. In this way, the manure liquid cannot pass directly through the perforated tube to contaminate the drive mechanism. In some embodiments, perforated track 124 has a plurality of ⅛ inch holes therethrough. Breaks through angle irons 119 and 121 have added (beneath reference numerals 117 and 121) by the patent illustrator to better illustrate this track.

The drive track may be formed from 304SS sheet having 3/16 perforations formed in 11 gauge sheet in some embodiments, with the hole flares disposed outward to provide traction for the drive wheels. Other, increased roughness surfaces may also be used to provide increased traction for the wheels. The angle irons may be used to form the drive track walls by using a clamp system to force the angle iron into round, leaving the two free ends of each angle iron somewhat apart but facing each other across a gap. If the gap is considered to be at 12 o'clock, then the angle irons can be welded to the underlying non-perforated outer tube sheet at 9 0'clock and 3 o'clock, then 10 o'clock and 4 o'clock, etc, with periodic tightening to reduce the gap between the angle iron ends.

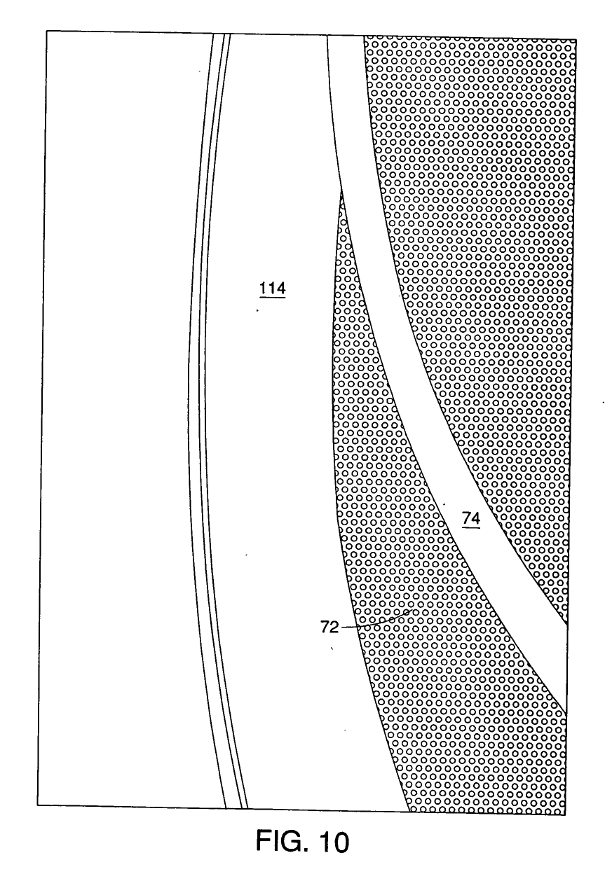

FIG. 10 illustrates the inside of perforated tube 72 showing both the perforated region and the non-perforated region 114 forming the inside of the drive track, previously discussed. One flight 74 may also be seen in FIG. 10.

FIG. 11 illustrates discharge end 88 of the outer tube. Un-perforated region 114 may be seen secured to perforated tube 72. In this embodiment, the internal flights may be seen as formed of two sets of flights. In some embodiments, the flights are formed of 3 inch wide stainless pieces that are welded end to end and formed into about a 36 inch outer diameter coil. In some models, the coil is then stretched out and welded to the inside of the outer tube. A first flight 174 may be seen as may a second flight 274. In the embodiment illustrated, flight 174 starts about 180° opposite flight 274 and may start further in from the discharge end of the two. Flight 174 may be seen to approach a first interruption 130. Interruption 130 is formed by bending flight 174 along a bend 134 forming a flap 132 which is then welded to perforated screen 72. Following flight 174 further inward, a second interruption may also be seen in one embodiment. Second flight 274 may also be seen to have an interruption 140 with a flap 136 followed by a second interruption 138. In some embodiments, each individual flight spirals helically, being interrupted twice, and performing about 2½, 3, or 4 revolutions within the interior of the tube, depending on the embodiment. The interruptions can allow liquid still present in the solid liquid mixture to escape backwards and perhaps downhill to be allowed to pass through the perforations in the perforated screen. The adjustable height legs, previously discussed, can be used to adjust the inclination of the tube, allowing the travel of the solid liquid mixture to be slightly uphill, allowing excess liquid to flow back downhill and have another chance to pass through the perforations in the perforated screen. The inclination can be varied between about 0 and 10 degrees in some embodiments. In use, a 3 to 4 degree inclination has been used. FIG. 11 again shows idler wheel 80 and drive wheel 81. Drive wheel 81 may be formed from polyurethane in some embodiments of the invention. In some embodiments, the drive wheel is a two piece wheel formed of an inner wheel of about 75 Shore D harness and an outer wheel, where the outer wheel has a Shore A hardness of about 54 A.

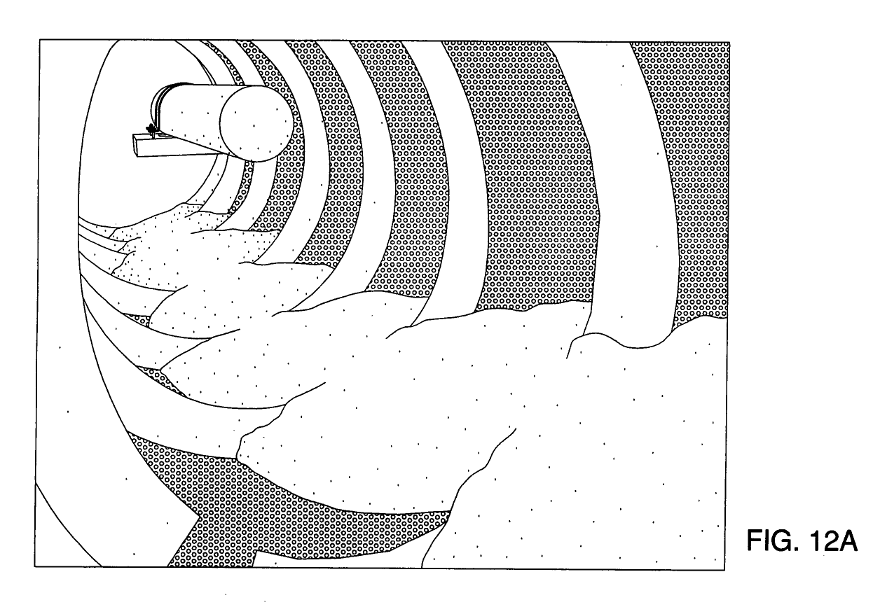

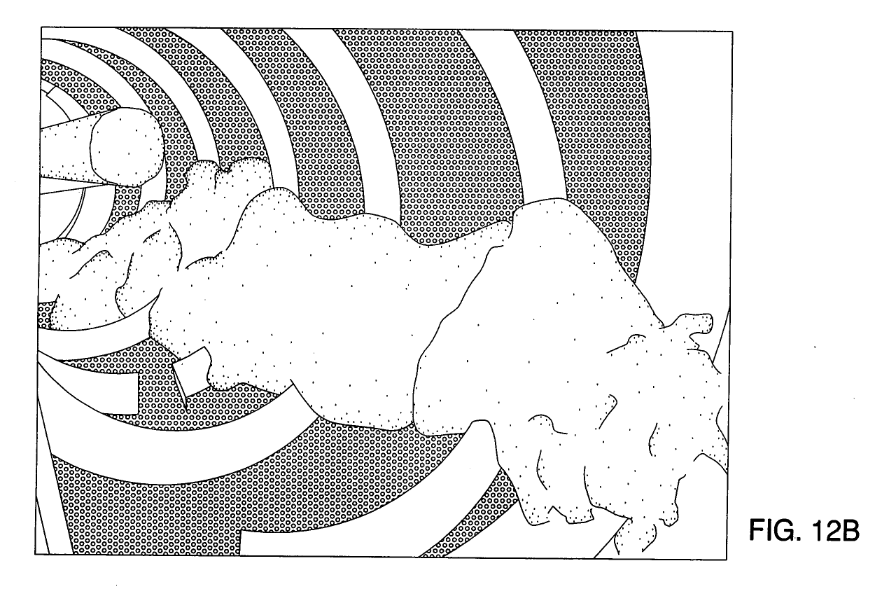

FIG. 12A is a perspective view of the wet manure being discharged from the inlet tube discharge slot, and the dewatering as the manure progresses along within the perforated outer tube.

FIG. 12B is a perspective view of the dry solid fraction being discharged from the manure separator. In some systems, a roller press can be used to receive the solid fraction being discharged from the rotary screen separator. Such a roller press unit can further increase the solids content of the manure.

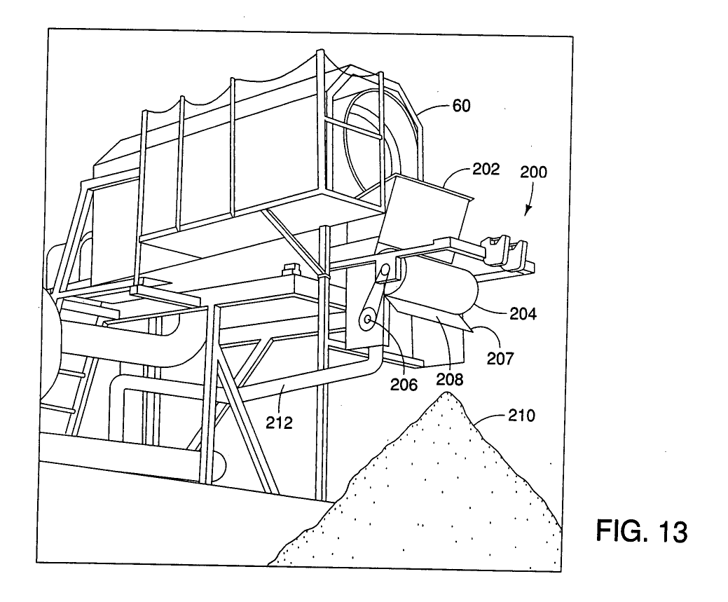

FIG. 13 illustrates a system according to the present invention including rotary screen separator 60, previously discussed, which is feeding a roller press unit 200. Roller press unit 200 includes a hopper 202 feeding a nip 208 formed between a top natural rubber roller 204 and a lower, perforated screen roller (not seen in FIG. 13). A doctor blade 207 can be used to scrape the solids from the roll. The central, rotational axis of perforated screen roller may be seen at 206. The manure forced into the nip can thus have water forced into the interior of the perforated screen roller which can be captured and collected through pipe 212, and which can be sent back through separator 60 in some systems according to the present invention. In some embodiments, the perforated screen roller can be formed of material similar to the rotary screen separator. In some embodiments, the lower, perforated screen roller is formed of stainless steel having perforations of about ⅛ inch in diameter.

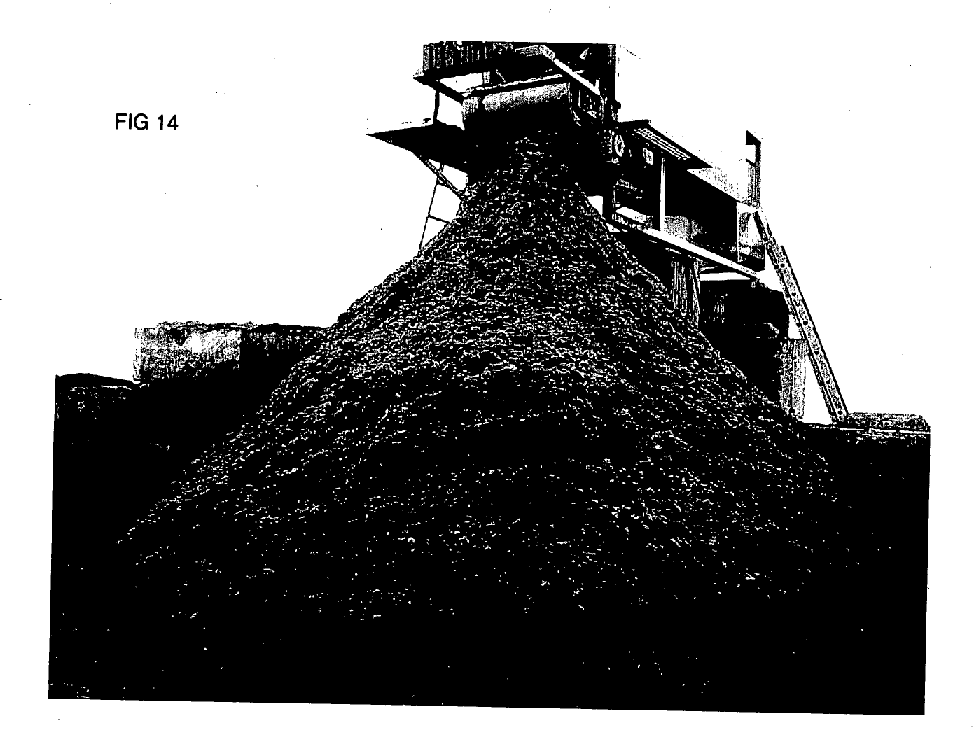

FIG. 14 is a photograph of a system similar to that of FIG. 13. Note the angle of repose, or the angle of the sides of the solid fraction pile under the roller press. This is indicative of the solids content of the solid fraction, which may be contrasted with the angle of repose expected of a wet manure pile. This angle may also be contrasted with the roughly horizontal surface expected of a pool of a nominally 95% liquid manure being fed to the separator.

FIG. 14 is a photograph of a system similar to that of FIG. 13, from sand bedding dairy flush barn manure. Note the angle of repose, or the angle of the sides of the solid fraction pile under the roller press. This is indicative of the solids content of the solid fraction, which may be contrasted with the angle of repose expected of a wet manure pile. This angle may also be contrasted with the roughly horizontal surface expected of a pool of a nominally 95% liquid manure being fed to the separator.

The liquid fraction stream from the rotary separator and from the roller press, where present, can then be passed through a settling device, such as a settling channel or chamber that may use a change of velocity to allow the sand to drop out. Concrete channels or basins may be used in some methods. The liquid may be removed and the sand removed, for example, with a bobcat.

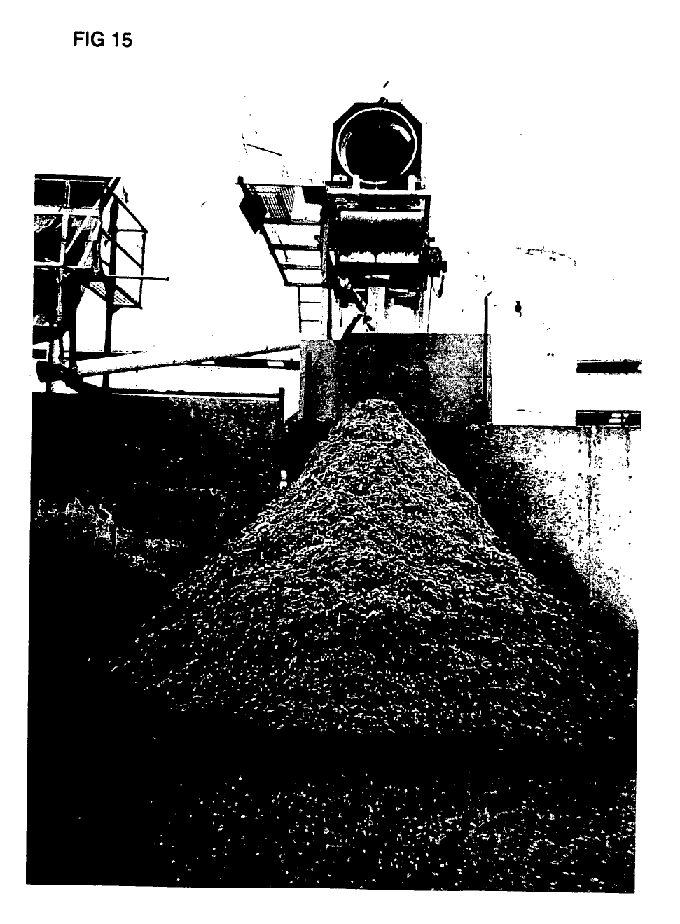

FIG. 15 is a photograph of a system similar to that in FIG. 13, showing the discharge and angle of repose of the solid fraction discharged from the roller press, from straw bedding dairy flush barn manure.

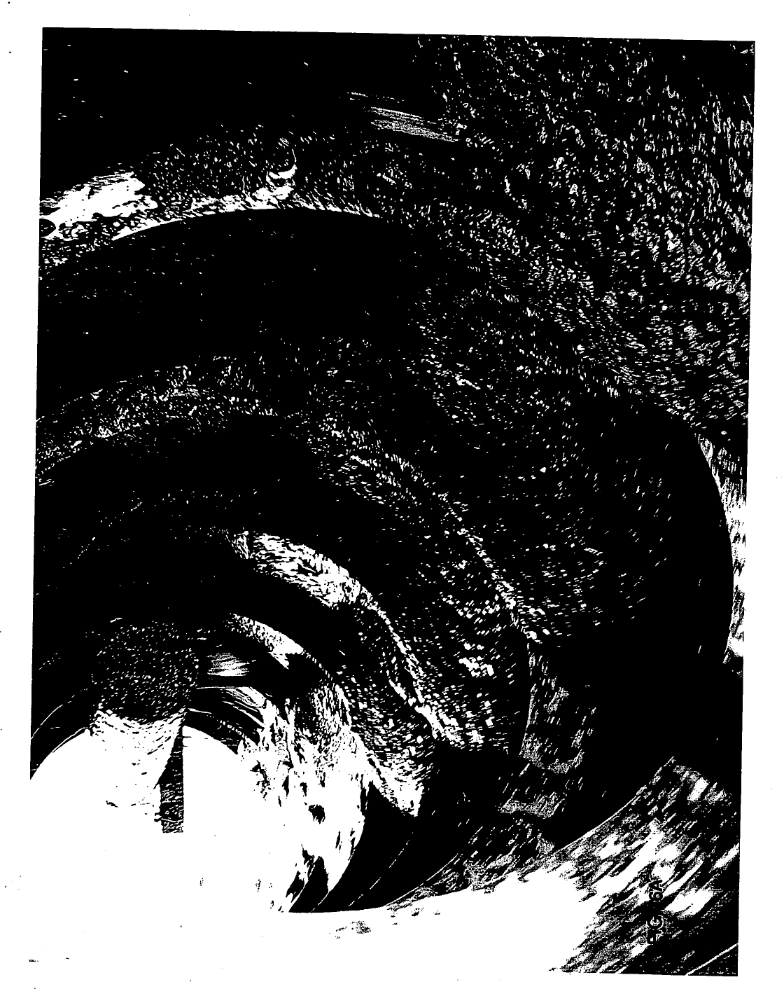

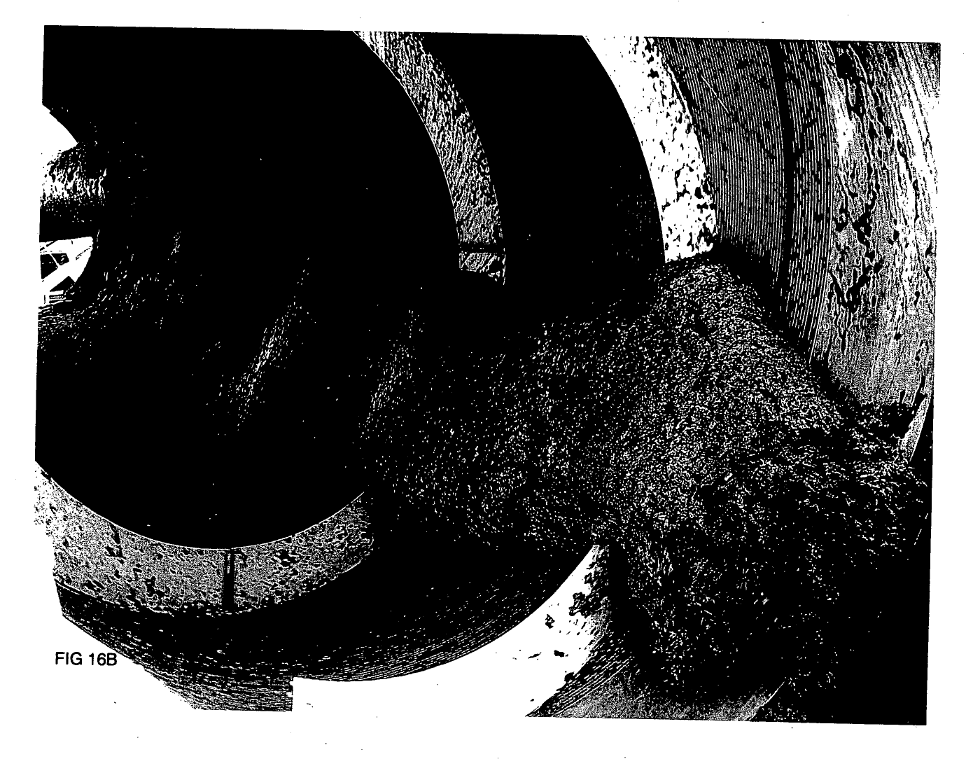

FIG. 16A is a photograph illustrating the wet nature of the manure being discharged from the inlet tube discharge slot, and the dewatering as the manure progresses through the perforated outer tube.

FIG. 16B is a photograph illustrating the dry and fibrous nature of the solid fraction being discharged from the manure separator. The rolling of the dewatered manure and the self-cleaning action of the manure may also be seen in the original photograph. While the manure appears to somewhat coat the sides of the outer tube upstream, the outer tube portion near the discharge appears to roll together, in a manner somewhat similar to bread dough. While not wishing to be bound to a theory, it appears to applicants that the manure is pulling material away from the perforations at this point, helping keep the perforations clear. In some uses and in some embodiments of the invention, a system according to the present invention can also include further dewatering. In some systems, a roller press can be used to receive the solid fraction being discharged from the rotary screen separator. Such a roller press unit can further increase the solids content of the manure.

The claims of the present invention described above are for purposes of illustration. The scope of the invention is described in the claims which follow.

What is claimed is:

1. A device for separating an animal manure inlet stream into a first, more liquid outlet stream and a second, more solid outlet stream, the device comprising:
a housing;
a tube rotatably disposed within the housing, the tube having an inlet end, an outlet end, a tube wall, an inside surface, a wall thickness, and a plurality of apertures through the wall thickness;
a motor operably coupled to rotate the tube;
a feed conduit disposed within the tube near the tube inlet end, the feed conduit having at least one conduit aperture for directing manure toward the tube inner surface;
in which the tube apertures have an average dimension of less than about ¼ inch.

2. The device of claim 1, in which the tube apertures have an average inside dimension of not greater than about 3/16 inch.

3. The device of claim 1, in which the tube apertures have an average inside area of less than about 0.05 square inch.

4. The device of claim 1, in which the tube apertures have an average inside dimension of about 1/16 inch.

5. The device of claim 1, in which the tube apertures have a substantially circular shape and in which the average inside dimension is an average inside diameter.

6. The device of claim 1, in which the tube wall thickness is thinner than about 12 gauge.

7. The device of claim 1, in which the motor rotatable coupling to the tube includes a first drive wheel driven by the motor and urged against the tube outer surface to engage the tube outer surface at a first end region to drive the tube rotation through a frictional force.

8. The device of claim 7, further comprising a second drive wheel driven by the motor and urged against the tube outer surface to engage the tube outer surface at a second end region opposite the first end region to drive the tube rotation through a frictional force.

9. The device of claim 8, in which the first drive wheel drives a portion of the outer tube through which liquid cannot flow.

10. The device of claim 8, in which the drive wheel is formed of a polymeric material.

11. The device of claim 8, in which the tube includes a drive track disposed about a tube outer circumference, the drive track being formed of a drive track material which is of a different material and/or surface configuration than the perforated tube wall, in which the drive track is adapted to receive the drive wheel.

12. The device of claim 8, in which the drive track includes a perforated metal disposed over a solid metal.

13. The device of claim 8, in which the drive track includes a lip on both sides of the track.

14. The device of claim 1, further comprising an overflow collector disposed near the tube inlet end to catch manure overflowing the tube inlet end.

15. The device of claim 1, in which the feed conduit has an elongate shape, a length, and in which the feed conduit aperture includes a slot disposed along the conduit length.

16. The device of claim 1, in which the feed conduit is configured to be rotated to adjust the angle of incidence of manure exiting the slot and impinging the tube wall inner surface.

17. The device of claim 1, in which the feed conduit is configured to be axially adjustable to vary the penetration depth into the outer tube, of the manure impinging the tube wall inner surface.

18. The device of claim 1, further comprising at least one inner protrusion helically disposed on the tube inner wall.

19. The device of claim 1, further comprising at least one flight helically disposed on the tube inner wall.

20. The device of claim 1, further comprising means for adjusting the inclination of the tube relative to horizontal, from end to end.

21. The device of claim 1, further comprising a roller press disposed to receive a solid fraction material from the rotating tube.

22. The device of claim 1, further comprising a settling chamber coupled to receive a liquid fraction that has passed through the rotating outer tube perforations for settling out sand from the liquid fraction.

23. A device for separating an animal manure inlet stream into a first, liquid fraction outlet stream and a second, solid fraction outlet stream, the device comprising:
a housing;
a tube rotatably disposed within the housing, the tube having an inlet end, an outlet end, a tube wall, an inside surface, a wall thickness, and a plurality of apertures through the wall thickness;
a motor operably coupled to rotate the tube; and
a feed conduit disposed within the tube near the tube inlet end, the feed conduit having at least one conduit aperture for directing manure toward the tube inner surface;
in which the tube apertures have an average inside dimension of less than about ¼ inch and take up at least about ⅓ of the tube surface,
in which the outer tube has a wall thickness thinner than about 12 gauge.

24. The device of claim 23, in which the motor rotatable coupling to the tube includes a drive wheel driven by the motor and urged against the tube outer surface to engage the tube outer surface to drive the tube rotation through a frictional force, the device having at least one drive wheel at each end of the outer tube, and in which the outer wheel drives a portion of the outer tube through which liquid cannot flow.

25. The device of claim 24, further comprising at least one inclination adjustment member operably coupled to the frame.

26. A method for separating an animal manure inlet stream into at least two outlet streams, the method comprising:
discharging the manure inlet stream against the inner rotating wall of a rotating outer tube having a plurality of perforations therethough;
collecting a first outlet stream comprising fluid that has flowed through the wall perforations; and
collecting a second outlet stream comprising solids that have been carried to the end of the rotating tube, wherein the second outlet stream has substantially higher solids content than the first outlet stream.

27. The method of claim 26, in which the manure is not substantially mechanically pressed against the inner rotating tube wall.

28. The method of claim 26, in which the tube wall perforations have an average, inside dimension of less than about ¼ inch.

29. The method of claim 26, in which the tube wall has a wall thickness thinner than about 12 gauge.

30. The method of claim 26, in which the tube wall has a wall thickness thinner than about 14 gauge.

31. The method of claim 26, in which the rotating tube has an inlet end and an outlet end, in which the tube is at tilted at least about 3 degrees relative to horizontal upward in the direction of the outlet end.

32. The method of claim 26, in which the manure has a percent solids of at least about 4 weight percent.

33. The method of claim 26, in which at least some of the inlet stream overflows the inlet end of the rotating tube into a vessel and is pumped back into the inlet stream.

34. The method of claim 26, in which the tube rotation is caused by a motor driving the outer tube with a drive wheel.

35. The method of claim 34, in which the driving includes driving the outer tube with a drive wheel at each end.

36. The method of claim 34, in which the driving includes driving the outer tube with a drive wheel on a portion of the outer tube through which liquids cannot pass.

37. The method of claim 34, in which the driving includes driving the outer tube with a polymeric drive wheel.

38. The method of claim 26, further including adjusting the discharge upward responsive to higher inlet flow rates and downward responsive to lower inlet flow rates.

39. The method of claim 26, in which the discharging includes discharging the manure from an inlet conduit, wherein the discharge occurs through at least one aperture in the inlet conduit.

40. The method of claim 39, in which the inlet conduit aperture includes at least one elongate slot.

41. The method of claim 26, in which the second outlet stream is carried at least in part by substantially spirally disposed inward protrusions within the tube.

42. The method of claim 41, in which the protrusions include spirally oriented flights.

43. The method of claim 42, in which the flights include at least one interruption to allow fluid to flow downhill.

44. The method of claim 26, the method further comprising receiving in the first outlet stream at least about 50 weight percent of the inlet stream, and receiving in the second outlet stream at least about 40 weight percent of the solids in the inlet stream.

45. The method of claim 26, in which the method further comprises receiving in the first outlet stream an amount of at least about 70 weight percent of the inlet stream and receiving the second outlet stream having at least about 50 weight percent of the solids in the inlet stream.

46. The method of claim 26, further comprising sending the second outlet stream from the rotating outer tube to a roller press and further removing liquid from the second outlet stream using the roller press to produce a roller press solid fraction.

47. The method of claim 46, in which the roller press solid fraction has less than about 80 weight percent liquid.

48. The method of claim 46, in which the roller press solid fraction has less than about 75 weight percent liquid.

49. A method for separating an animal manure inlet stream into at least two outlet streams, the method comprising:
discharging the manure inlet stream against the inner rotating wall of a rotating tube having a plurality of perforations therethough, in which the rotating tube has an inlet end and an outlet end, in which the tube wall perforations have an average inside area of less than about 0.05 square inches, in which the tube wall has a wall thickness thinner than about 12 gauge;
collecting a first outlet stream comprising fluid and material that has flowed through the wall perforations; and
collecting a second outlet stream discharged from the tube outlet end, wherein the second outlet stream has a substantially higher solids content than the first outlet stream.

50. The method of claim 49, in which at least some of the inlet stream overflows the inlet end of the rotating tube into a vessel and is pumped back into the inlet stream.

51. The method of claim 49, in which the tube rotation is caused by a motor driving the outer tube with a drive wheel at each end of the outer tube.

52. The method of claim 49, in which the tube is at tilted between about 1 and 5 degrees relative to horizontal, upward toward the direction of the outlet end.

53. The method of claim 49, in which the second outlet stream comprises at least about 10 weight percent solids and contains at least about 50 percent of the solids in the inlet stream manure.

54. The method of claim 49, in which the inlet stream manure comprises at least about 10 weight percent sand.

55. The method of claim 49, in which the collecting continues for over an hour without plugging the outer tube.
